(19) United States
(12) Patent Application Publication
(10) Pub. No.: US 2023/0377014 A1
(43) Pub. Date: Nov. 23, 2023

(54) ASSISTANCE SYSTEM, COMPUTER PROGRAM FOR ASSISTANCE SYSTEM, AND METHOD OF CONTROL FOR ASSISTANCE SYSTEM

(71) Applicant: MISUMI GROUP INC., Tokyo (JP)

(72) Inventors: Kenji NAKAGAWA, Tokyo (JP); Tomohiro ASANO, Tokyo (JP); Misa SONG, Tokyo (JP); Wataru KADOBAYASHI, Tokyo (JP); Shimpei YAMAGUCHI, Tokyo (JP)

(73) Assignee: MISUMI GROUP INC., Tokyo (JP)

(21) Appl. No.: 18/044,723

(22) PCT Filed: Feb. 10, 2022
(86) PCT No.: PCT/JP2022/005291

§ 371 Date: Mar. 9, 2023

(30) Foreign Application Priority Data
Mar. 12, 2021 (JP) 2021-039935

(51) Int. Cl. G06Q 30/0601; G06T 19/00; G06T 15/20

(52) U.S. Cl. CPC G06Q 30/0621; G06T 19/00; G06T 15/20; G06T 2219/004

(57) ABSTRACT

An assistance system assisting communication between a supplier providing an article-related service requiring work for an article and a user demanding provision thereof, has: an acquisition unit acquiring three-dimensional model data of the article based on a user instruction; an article presentation unit presenting one of the user and supplier with an article screen expressing the article observed from a predetermined viewpoint, based on the three-dimensional model data; an annotation data generation unit generating annotation data for displaying an annotation screen obtained by writing annotation information on the presented article screen so as to include viewpoint information specifying the viewpoint; an annotation data acquisition unit acquiring the generated annotation data; and an annotation presentation unit presenting another of the user and supplier with the annotation screen based on the acquired annotation data from a viewpoint corresponding to the viewpoint information of the annotation data.

### CROSS-REFERENCE TO RELATED PATENT APPLICATIONS

This application is a U.S. National Phase application under 35 U.S.C. § 371 of International Patent Application No. PCT/JP2022/005291 filed on Feb. 10, 2022 and claims the benefit of priority to Japanese Patent Application No. 2021-039935 filed on Mar. 12, 2021, the contents of all of which are incorporated herein by reference in their entireties. The International Application was published in Japanese on Sep. 15, 2022 as International Publication No. WO 2022/190759 under PCT Article 21(2).

### FIELD OF THE INVENTION

The present invention relates to an assistance system for assisting with communication by presenting an annotation screen on which annotation information has been written, a computer program for the assistance system, and a method of control for the assistance system.

### BACKGROUND OF THE INVENTION

Patent Literature 1 discloses an automatic estimation system. In the automatic estimation system, a shape recognition processing part recognizes a shape of an item described in shape data input by a user. In addition, a display information processing part acquires selectable manufacturing conditions based on a type of the item input by the user and the recognized shape of the item. Furthermore, a display processing part displays an outline of the recognized item in an item shape display part and displays the manufacturing conditions in a manufacturing condition selection part on a displayed screen. The user selects any manufacturing condition among the manufacturing conditions displayed in the manufacturing condition selection part. In addition, the user selects an estimation start part being displayed in a display part to cause the automatic estimation system to start estimation processing.

### CITATION LIST

### Patent Literature

[Patent Literature 1] JP2016-062403A

### Technical Problem

A user who desires to be provided with an article-related service requiring work related to an article follows procedures including estimation to close a transaction with a supplier who provides the article-related service. At this point, either the user or the supplier may wish to convey information such as a request related to the work to the other party. However, when a user and a supplier at different locations communicate with each other, environments differ between the user and the supplier. Therefore, compared to a case where information is conveyed face-to-face, communication must be repetitively performed in order to share accurate information and communication becomes cumbersome.

### Solution to Problem

### SUMMARY OF THE INVENTION

An assistance system according to an aspect of the present invention is an assistance system assisting with communication between a supplier providing an article-related service which requires work related to an article and a user demanding provision of the article-related service, the assistance system comprising: an acquisition unit configured to acquire three-dimensional model data of the article based on an instruction by the user; an article presentation unit configured to present one of the user and the supplier with an article screen, which expresses the article as observed from a predetermined point of view, based on the three-dimensional model data; an annotation data generation unit configured to generate annotation data for displaying an annotation screen obtained by writing annotation information on the presented article screen so that the annotation data includes point of view information which specifies the point of view; an annotation data acquisition unit configured to acquire the generated annotation data; and an annotation presentation unit configured to present another of the user and the supplier with the annotation screen based on the acquired annotation data from a point of view corresponding to the point of view information included in the annotation data.

A computer program for an assistance system according to an aspect of the present invention is a computer program for an assistance system which includes a computer and which is configured to assist with communication between a supplier providing an article-related service which requires work related to an article and a user demanding provision of the article-related service, the computer program causing the computer to function as: an acquisition unit configured to acquire three-dimensional model data of the article based on an instruction by the user; an article presentation unit configured to present one of the user and the supplier with an article screen, which expresses the article as observed from a predetermined point of view, based on the three-dimensional model data; an annotation data generation unit configured to generate annotation data for displaying an annotation screen obtained by writing annotation information on the presented article screen so that the annotation data includes point of view information which specifies the point of view; an annotation data acquisition unit configured to acquire the generated annotation data; and an annotation presentation unit configured to present another of the user and the supplier with the annotation screen based on the acquired annotation data from a point of view corresponding to the point of view information included in the annotation data.

A method of control for an assistance system according to an aspect of the present invention is a method of control for an assistance system which includes a computer and which is configured to assist with communication between a supplier providing an article-related service which requires work related to an article and a user demanding provision of the article-related service, the method of control causing the computer to: acquire three-dimensional model data of the article based on an instruction by the user; present one of the user and the supplier with an article screen, which expresses the article as observed from a predetermined point of view based on the three-dimensional model data; generate annotation data for displaying an annotation screen obtained by writing annotation information on the presented article screen so that the annotation data includes point of view information which specifies the point of view; acquire the generated annotation data; and present another of the user and the supplier with the annotation screen based on the acquired annotation data from a point of view corresponding to the point of view information included in the annotation data.

### BRIEF DESCRIPTION OF THE DRAWINGS

FIG. 1 is a schematic view showing an overall configuration of a transaction assistance system.

FIG. 2 is a schematic block diagram of the transaction assistance system.

FIG. 3 is a schematic block diagram of a server control part.

FIG. 4 is a schematic view showing a project detail screen.

FIG. 5 is a schematic view showing an annotation screen.

FIG. 6 is a schematic view showing a case detail screen.

FIG. 7 is a schematic view showing product specifications.

FIG. 8 is a flow chart of an assistance flow.

### DETAILED DESCRIPTION OF THE INVENTION

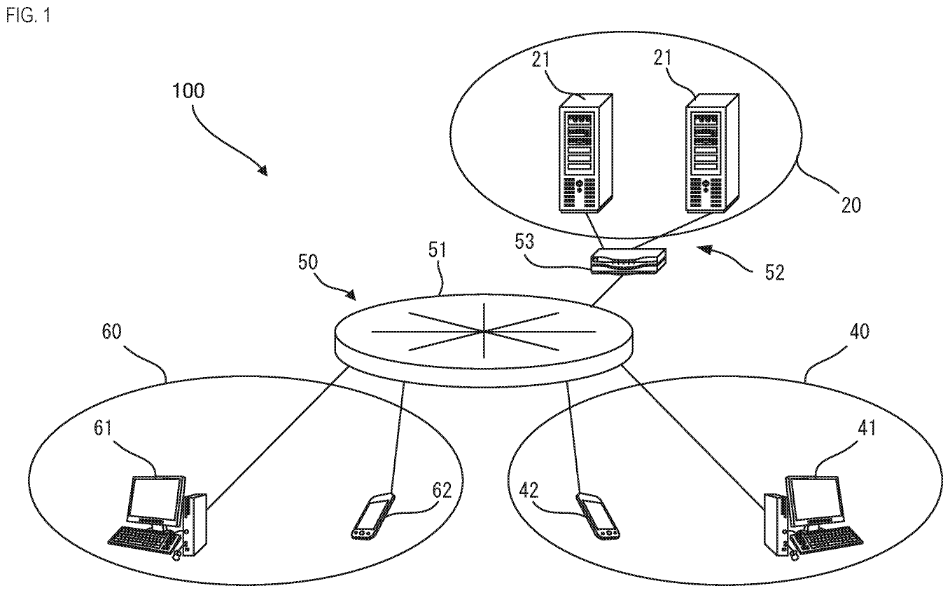

FIG. 1 shows a transaction assistance system 100 which is an example of an assistance system for assisting with communication between a supplier who provides an article-related service (hereinafter, also simply referred to as a “service”) requiring work related to an article and a user who desires to be provided with the article-related service. The transaction assistance system 100 assists the closing of a transaction by determining a provision requirement (for example, product specifications which the supplier is capable of accepting) for providing a service between a supplier who provides the service and a user who desires to be provided with the service. A transaction includes a service provision agreement such as an agreement to provide any of services including manufacturing, processing, data creation, and measurement. In addition, a transaction includes an agreement to provide other work related to service provision such as an agreement to provide work including estimation, creation of specifications, and introduction.

The transaction assistance system 100 is configured as a network system or a client-server system. However, the transaction assistance system 100 may be constituted of a single server apparatus. In addition, the transaction assistance system 100 includes a transaction assistance server 20, and a user terminal 40 and a supplier terminal 60 as clients which are communicably connected to the transaction assistance server 20 via a network 50. The user terminal 40 and the supplier terminal 60 are computer apparatuses which can be connected to a network. For example, the user terminal 40 includes various devices which can be connected to a network such as a stationary computer apparatus 41 or a mobile terminal 42 such as a smartphone. In a similar manner, the supplier terminal 60 includes devices such as a computer apparatus 61 or a mobile terminal 62.

The transaction assistance server 20 is configured as a single logical server apparatus by combining a plurality of server units 21 as a plurality of computers. However, the transaction assistance server 20 may be constituted of a single server unit 21. Alternatively, the transaction assistance server 20 may be logically constructed using cloud computing. The transaction assistance server 20 may authenticate a user by receiving user identification information which identifies the user from the user terminal 40. In addition, the transaction assistance server 20 may authenticate a supplier by receiving supplier identification information which identifies the supplier from the supplier terminal 60.

Furthermore, the transaction assistance server 20 may save various kinds of data uploaded by the authenticated user or supplier. In this case, the transaction assistance server 20 may provide the user terminal 40 and the supplier terminal 60 with saved data. In addition, the transaction assistance server 20 may perform processing such as arranging for a service ordered by the user, delivery of a product, and charging for provision of the service. Furthermore, the transaction assistance server 20 may collect a fee with respect to the provision of the service by the supplier from the user. Moreover, the transaction assistance server 20 may collect a fee for using the transaction assistance system 100 from the user or the supplier.

The network 50 is configured to be capable of respectively connecting the user terminal 40 and the supplier terminal 60 to the transaction assistance server 20. As an example, the network 50 is configured to realize network communication using the TCP/IP protocol. Specifically, a LAN 52 connects the transaction assistance server 20 and the Internet 51 to each other. In addition, the Internet 51 as a WAN and the LAN 52 are connected via a router 53. The user terminal 40 and the supplier terminal 60 are also configured to be connected to the Internet 51. Furthermore, the network 50 may be any of a dedicated line, a telephone line, an intranet, a mobile communication network, other communication lines, or a combination thereof and may be either a wired or a wireless network. The server units 21 of the transaction assistance server 20 may be connected to each other by the Internet 51 in place of or in addition to the LAN 52.

By implementing various kinds of computer software, the user terminal 40 and the supplier terminal 60 enables the user and the supplier to reap the benefits of assistance by the transaction assistance server 20. In addition, the user terminal 40 and the supplier terminal 60 are either equipped with a display part which is a display apparatus such as a display or a touch panel or connected to a display part in a wired or wireless manner. Furthermore, the user terminal 40 and the supplier terminal 60 may be any of various kinds of computer apparatuses such as a book-type personal computer and a portable tablet terminal apparatus.

The transaction assistance server 20 provides guidance via the user terminal 40 and the supplier terminal 60 on various procedures necessary for closing a transaction between the supplier and the user. As an example, the transaction assistance server 20 is configured as a web server which causes various web pages to be displayed on the user terminal 40 and the supplier terminal 60 in accordance with accesses made from the user terminal 40 and the supplier terminal 60. Hereinafter, a case where the user terminal 40 and the supplier terminal 60 use a web browser to display web pages will be described as an example.

[Outline of Guided Procedures]

As an example, the transaction assistance server 20 provides guidance on procedures such as those described below. First, the user accesses a web page provided by the transaction assistance server 20 from the user terminal 40. Subsequently, the transaction assistance server 20 authenticates the user terminal 40 using user information such as user identification information and a password which has been acquired in advance and which is stored for each user. In addition, the transaction assistance server 20 presents the user with a service candidate group including a plurality of article-related services which the user can be provided with. Each service which makes up the service candidate group is associated with service information of each service which is used in relation to selecting a service. As an example, the transaction assistance server 20 causes a virtual card (hereinafter, also referred to as a “service card”) which is associated with service information via card identification information for identifying each card to be lined up and displayed in the display part of the user terminal 40 as a service which makes up the service candidate group.

The user picks out a service card corresponding to a desired service from the displayed service candidate group. For example, when the user designates a service card, the transaction assistance server 20 displays at least a part of service information. As an example, the service information includes content information indicating contents of a service associated with the service card, supplier information which enables the user to comprehend a supplier who provides each service, and case example information indicating a case example of the service provided by the supplier. In addition, the user selects a service card associated with a desired service using the service information. In the present specification, the designation by the user includes a designation by voice input or the like or a designation automatically performed by the system accompanying some kind of a user operation in addition to a designation by an operation via an input apparatus such as a touch operation or a click operation with respect to an icon or the like.

In response to the selection operation by the user, the transaction assistance server 20 selects a service card and associates the service card with user information. As an example, the transaction assistance server 20 stores card identification information in association with user identification information. In addition, when the user performs an operation for using the selected service card, the transaction assistance server 20 includes the selected service card in at least one of projects to be a unit for managing a plurality of processing steps (or tasks) for determining a provision requirement. In this case, the transaction assistance server 20 may include the service card in a newly created project or include the service card in a project which has already been created.

When the user selects a project, the transaction assistance server 20 causes an information item required by the supplier to determine the provision requirement to be displayed. The information item is set in association with each service card included in the selected project or, in other words, in association with each selected service. The user inputs request information (for example, product specifications) for specifying a request by the user with respect to the information item. In addition, the user performs an operation for asking the supplier for an estimation. Furthermore, the transaction assistance server 20 saves the request information and notifies the supplier that an estimation has been requested.

The supplier (including a person in charge of the supplier) confirms the notification from the transaction assistance server 20 and accesses the web page provided by the transaction assistance server 20 from the supplier terminal 60. Subsequently, the transaction assistance server 20 authenticates the supplier terminal 60 using supplier information such as supplier identification information and a password which has been acquired in advance and which is stored for each supplier. In addition, the transaction assistance server 20 causes a project list including a project for which an estimation has been requested in the display part of the supplier terminal 60. When the supplier selects the project for which an estimation has been requested, the transaction assistance server 20 causes request information input by the user to be displayed. Furthermore, the supplier confirms the request information, inputs an estimation, and sends a reply to the user. In addition, the transaction assistance server 20 stores a content of the estimation and notifies the user that an estimation reply has been sent. Furthermore, when necessary, the user or the supplier can contact each other using a communication function to be described later.

[Transaction Assistance Server]

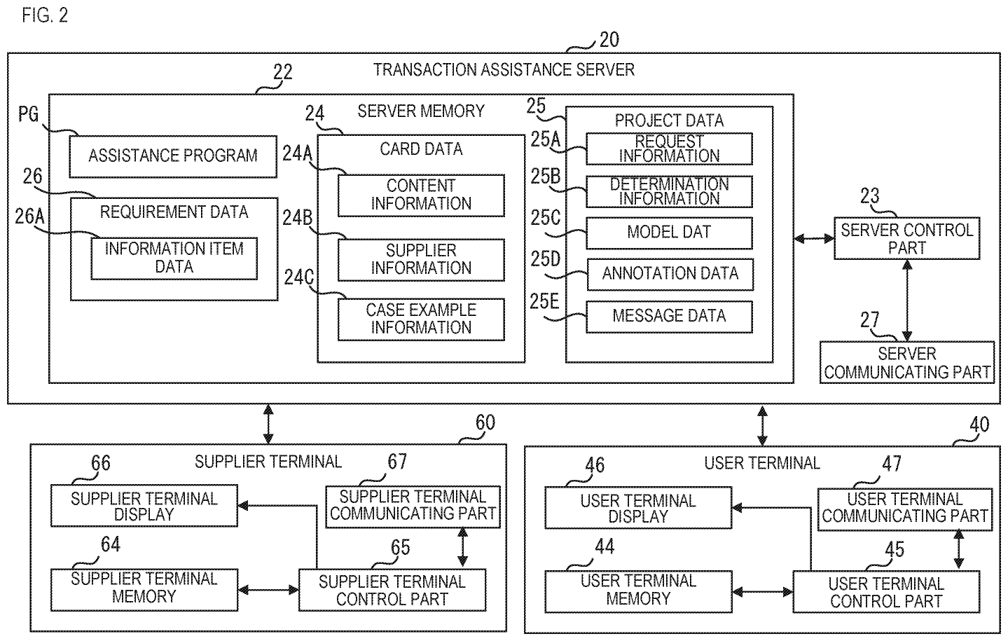

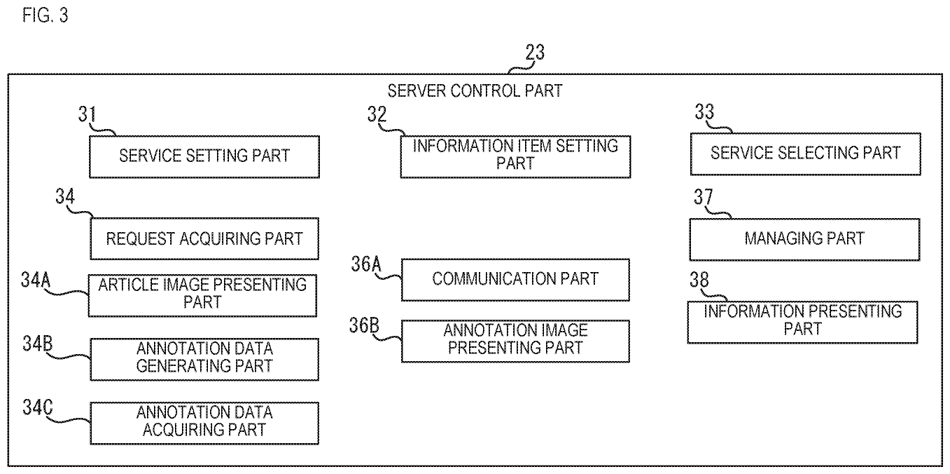

A control system of the transaction assistance server 20 will be described with reference to FIGS. 2 and 3. The transaction assistance server 20 includes a server control part 23 which controls the transaction assistance server 20 and a server memory 22 being an example of a storage means which stores an assistance program PG. The server control part 23 is configured as a computer combining a processor which executes various calculation processing steps and operation control in accordance with a predetermined program with other peripheral apparatuses. In addition, the transaction assistance server 20 includes a server communicating part 27 as an example of a communication apparatus which transmits and receives data to and from the user terminal 40 and the supplier terminal 60. Alternatively, a cloud-type database may function as the storage means.

As an example, the processor of the server control part 23 is a CPU (Central Processing Unit) or an MPU (Micro-Processing Unit) which controls the entire transaction assistance server 20 and comprehensively controls various processing steps based on a program stored in the server memory 22. In addition, the server memory 22 is a computer-readable non-transitory storage medium. The storage medium includes storage apparatuses such as a RAM (Random Access Memory) which is a system work memory for the processor to operate and a ROM (Read Only Memory), an HDD (Hard Disc Drive), an SSD (Solid State Drive), and the like which store a program and system software. Hereinafter, a case where the processor executes various processing operations such as calculations, control, and discrimination in accordance with the assistance program PG which is stored in the ROM or the HDD and which is an example of a computer program. The assistance program PG causes the server control part 23 which is an example of a computer to function as each functional part.

An interface including a keyboard or various switches for inputting predetermined commands and data is connected to the server control part 23 in a wired or wireless manner. In addition, a monitor for displaying an input state, a setting state, or a measurement result of an apparatus and various kinds of information is connected to the server control part 23 in a wired or wireless manner. Furthermore, the server control part 23 can also perform control in accordance with a program stored in a portable recording medium such as a CD (Compact Disc), a DVD (Digital Versatile Disc), a CF (Compact Flash) card, or a USB (Universal Serial Bus) memory or in an external storage medium such as a server on the Internet.

The server control part 23 will be further described with reference to FIG. 3. The server control part 23 includes a service setting part 31 which is an example of a service setting means, an information item setting part 32 which is an example of an information item setting means, a service selecting part 33 which is an example of a service selection means, and a request acquiring part 34 which is an example of an acquisition means. In addition, the server control part 23 includes an article image presenting part 34A which is an example of an article presentation means, an annotation data generating part 34B which is an example of an annotation data generation means, and an annotation data acquiring part 34C which is an example of an annotation data acquisition means. Furthermore, the server control part 23 includes a communication part 36A which is an example of a communication means and an annotation image presenting part 36B which is an example of an annotation presentation means. Moreover, the server control part 23 includes a managing part 37 which is an example of a management means and an information presenting part 38 which is an example of an information presentation means for presenting the user or the supplier with various kinds of information.

The service setting part 31, the information item setting part 32, the service selecting part 33, the request acquiring part 34, the article image presenting part 34A, the annotation data generating part 34B, the annotation data acquiring part 34C, the communication part 36A, the annotation image presenting part 36B, the managing part 37, and the information presenting part 38 each function as a functional part as the server control part 23 executes the assistance program PG. Each functional part is a logical apparatus which is realized by cooperation between computer hardware and software. At least a part of the functional parts can be provided in the user terminal 40 or the supplier terminal 60. In addition, at least a part of the functional parts may be provided in external computer apparatuses. In this case, programs of the respective apparatuses cooperate to function as the assistance program PG.

[Service Setting Means]

The service setting part 31 sets, in association with service information of each service which is used in relation to selecting a service, a service candidate group including a plurality of article-related services which the user can be provided with. For example, the service setting part 31 sets, in association with service information, a service candidate group made up of services input by the supplier or a manager of the transaction assistance server 20. The user can use the service information by referring to the service information and select a service. Furthermore, an AI created by machine learning can refer to service information based on information (such as a keyword used for a search and a past transaction history) acquired from the user and automatically select a service.

In addition, the service setting part 31 sets information which enables the user to comprehend each service as service information. As an example, the supplier sends a service to be included in the service candidate group and service information corresponding to the service to the transaction assistance server 20 via the supplier terminal 60. In addition, the service setting part 31 sets the service as a part of the service candidate group in association with the received service information. Furthermore, the service setting part 31 sets a service card as a medium of information which enables the user to comprehend each service. As another example, information which enables the user to comprehend each service may be a service name, an image, or a character string indicating an outline of each service.

The service selecting part 33 presents the user with at least a part of the services included in the service candidate group as options in selecting a service. As an example, the service selecting part 33 presents the user with the service card indicating each service which makes up the service candidate group. However, the service selecting part 33 may present a plurality of images, service names, or the like which correspond to services side by side as information which enables the user to comprehend each service. As an example, an article-related service is a service which requires work by the supplier related to an article such as manufacturing, processing, data creation, or measurement. In addition, the article-related services include an article manufacturing service which requires the article being manufactured by the supplier as work.

In addition, card data 24 as an example of service information is stored in the server memory 22 (FIG. 2). The card data 24 includes content information 24A indicating a content of a service associated with the service card, supplier information 24B which enables the user to comprehend a supplier who provides each service, and case example information 24C indicating a case example of the service provided by the supplier. Furthermore, the content information 24A, the case example information 24C, and the supplier information 24B are associated with each other via the service card. For example, the content information 24A, the case example information 24C, and the supplier information 24B are stored in association with card identification information. In addition, the card data 24 includes various kinds of information necessary for displaying the service card, for example, includes information such as an image related to a service, a configuration of a service card, and a display position of the service card.

When the user performs a predetermined operation, the content information 24A is displayed by the information presenting part 38. For example, when the user performs a click operation or the like which designates the service card, the information presenting part 38 causes a web page in accordance with the operation to be displayed in the display part of the user terminal 40. The information presenting part 38 may cause the web page to be displayed as a new web page or displayed side by side with or on top of a web page which is already displayed on a same screen. As an example, the information presenting part 38 causes a service content screen which presents the content information 24A, a supplier screen which presents the supplier information 24B, or a case example screen which presents the case example information 24C to be displayed.

[Information Item Setting Means]

The information item setting part 32 sets, for each article-related service included in the service candidate group, an information item required by the supplier to determine a provision requirement. For example, the information item setting part 32 sets an information item based on an instruction from the supplier who provides the service. Specifically, the information item setting part 32 sets an information item input by the supplier or the manager of the transaction assistance server 20 as an item for which the user can upload, input, or select data. For example, requirement data 26 stored in the server memory 22 includes information item data 26A indicating an information item of each service. In addition, each information item is included in the information item data 26A in a state of being associated with card identification information and supplier identification information. The supplier can determine whether or not the supplier is capable of meeting the provision requirement based on the information input or selected by the user with respect to the information item. Accordingly, the supplier need not repetitively ask the user to provide information. Therefore, the number of times the supplier and the user communicate with each other can be reduced, adjustment work for closing a transaction can be simplified and, at the same time, a mismatch can be prevented from being revealed after the closing of the transaction.

As an example, the supplier sends an information item corresponding to a service to the transaction assistance server 20 via the supplier terminal 60. In addition, the information item setting part 32 sets the received information item for each service in association with card identification information and includes the set information item in the information item data 26A. As an example, the information item is a name of the user, a point of contact, a name of a person in charge, a desired price, a desired delivery time, a size, a tolerance, a color, a shape, a quantity, a service category, an application, a crafting method, a material, contents of processing, a presence or absence of aftertreatment, contents of aftertreatment, a presence or absence of pretreatment, contents of pretreatment, apparatuses used in processing, or the like. The user can input or select a quantity of a desired article by pull-down or via an input apparatus. Furthermore, the user can also upload three-dimensional model data or the like with respect to the information item.

In addition, the information item setting part 32 sets three-dimensional model data for specifying an article and a work condition which designates a condition of work which the supplier must perform with respect to the article as the information items required by the supplier with respect to the article-related service. For example, the information item setting part 32 sets an information item for which the three-dimensional model data is to be uploaded. In this case, the request acquiring part 34 acquires the three-dimensional model data uploaded with respect to the information item set by the information item setting part 32 as request information. In addition, as the work condition, the information item setting part 32 sets items such as a method of manufacturing or a method of processing the article, a measurement method, a material of the article, a presence or absence of aftertreatment, a presence or absence of post-processing, apparatuses used to manufacture or process the article, and a measurement apparatus.

Furthermore, when the article manufacturing service described above is included in the service candidate group, the information item setting part 32 sets a manufacturing condition to be instructed with respect to manufacturing the article as the work condition. For example, the information item setting part 32 sets a manufacturing condition such as the method of manufacturing or the method of processing the article, the material of the article, the presence or absence of aftertreatment, the presence or absence of post-processing, or the apparatuses used to manufacture or process the article as the item of the work condition.

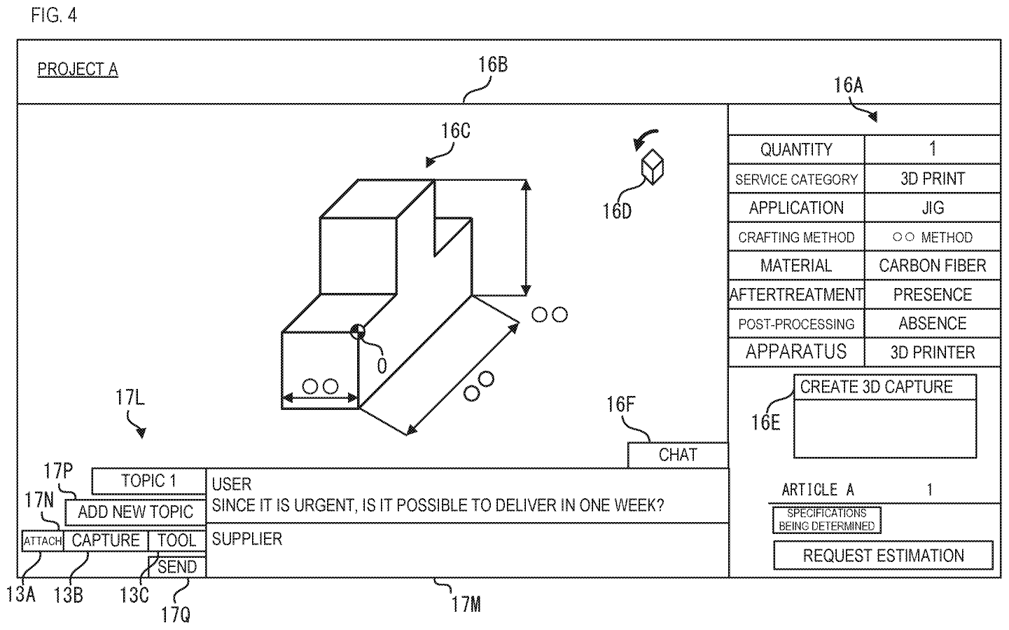

As an example, when the user completes a selection of a service card, a project list screen is displayed. In addition, an upload field is provided on the project list screen as an information item which is set in order to cause data to be uploaded. The user can upload desired data by a drag operation and a drop operation, an operation for designating a file, or the like. Furthermore, When the user selects a project on the project list screen, a project detail screen shown in FIG. 4 is displayed. When a plurality of service cards are selected in the selected project, a plurality of project detail screens may be displayed. Alternatively, project detail screens may be displayed so as to be switchable. FIG. 4 shows a project detail screen in a case where Project A has been selected. In addition, the project detail screen displays an information item field 16A and set information items are included in the information item field 16A. In FIG. 4, as information items, the information item field 16A displays items of work conditions such as a quantity, a service category, an application, a crafting method, a material, a presence or absence of aftertreatment, a presence or absence of post-processing, and apparatuses. Examples of information items other than work conditions include a point of contact, a name of a requester, case identification information (such as a management number or a case ID) for identifying a requested matter, and a model number of the article.

[Service Selection Means]

The service selecting part 33 selects an article-related service to be provided in response to a request by the user from the service candidate group. In addition, the service selecting part 33 selects an article-related service using service information and selection information acquired based on an instruction by the user. Specifically, the service selecting part 33 presents the user with at least a part of the services included in the service candidate group as options in selecting a service. At this point, the service selecting part 33 uses service information so that the service information is presented to the user in association with the presentation of the options. For example, the service selecting part 33 presents the user with service information by displaying the service information in a part of a service card.

Furthermore, the service selecting part 33 acquires, as selection information, service specific information for specifying the service selected by the user. As an example, the service specific information is card identification information which identifies the service card. For example, when the user designates the service card, the service selecting part 33 acquires the card identification information of the designated service card and selects a service. In addition, the service selecting part 33 causes the server memory 22 to store the card identification information of the designated service card.

When an AI automatically selects a service using service information, the service selecting part 33 may select a service in accordance with service specific information which is specified by the selection by the AI. In this case, the service selecting part 33 need not present the user with the service card as an option. For example, the AI may specify a service based on a keyword input on a service card list screen by the user in a state where no service card is being presented. Alternatively, the AI may specify a service using information on the user (for example, a history of past transactions) in a state where the user has logged into the transaction assistance system 100 and no service card is being presented. When the AI specifies a service card, the service selecting part 33 acquires card identification information of the specified service card.

Once the selection of a service card is completed, the managing part 37 generates a project in association with the selection of a service by the service selecting part 33. For example, the managing part 37 causes the server memory 22 to store the card identification information in association with project identification information which identifies the project. Accordingly, the selected service is included in the generated project. Alternatively, the managing part 37 may associate the service selected by the service selecting part 33 with an existing project which has already been created.

[Acquisition Means]

The request acquiring part 34 acquires the three-dimensional model data of an article based on an instruction by the user. In addition, the request acquiring part 34 may acquire, based on an instruction by the user, a work condition which designates a condition of work to be performed by the supplier with respect to the article. For example, the request acquiring part 34 acquires the three-dimensional model data uploaded via the project list screen and a work condition selected or input via the project detail screen. A work condition is information which designates a condition of work to be performed by the supplier with respect to an article. For example, in an article manufacturing service, the work condition is a manufacturing condition such as a manufacturing method.

In addition, the request acquiring part 34 may acquire other pieces of request information based on an instruction by the user. The request information is information for specifying a request by the user with respect to an information item which is set in association with a service selected by the service selecting part 33. For example, the request information is information (for example, product specifications) having been instructed by a selection or an input by the user with respect to an information item on the project detail screen (FIG. 4). The instruction by the user is not limited to an instruction by an upload operation, a selection operation, or an input operation. The instruction by the user may be an instruction by an operation performed by the user to confirm information having been automatically selected or input by the system or to confirm initially-set information.

### [Article Presentation Means]

Based on the three-dimensional model data acquired by the request acquiring part 34, the article image presenting part 34A presents one of the user and the supplier with an article screen expressing the article as observed from a predetermined point of view. An example of the article image presenting part 34A presenting the supplier with the article screen will be described later.

As an example of presenting the user with the article screen, on the project detail screen shown in FIG. 4, a model display field 16B which is an example of the article screen is displayed to the left of the information item field 16A in FIG. 4. In addition, a three-dimensional model 16C is displayed in the model display field 16B. The user can change the point of view from which the three-dimensional model 16C is observed by designating a point of view icon 16D in the model display field 16B. Alternatively, the point of view from which the three-dimensional model 16C is observed may be changed by an operation by the user involving moving the three-dimensional model 16C. In addition, the article image presenting part 34A presents the user with an article screen displaying an article image representing the article as observed from the predetermined point of view based on the three-dimensional model data. In this case, the article image is an image representing the three-dimensional model 16C as observed from a predetermined point of view. Viewer software which displays the three-dimensional model 16C while enabling the point of view to be changed may be distributed to the user terminal 40 and the supplier terminal 60 in advance or may be a web application which runs on a web browser.

Furthermore, the article image presenting part 34A may display, based on an instruction by the user or the supplier, the article as observed from another point of view which differs from the point of view of observation in the article image already being displayed. As an example, when the point of view of observation in the article image already being displayed is changed, the article image presenting part 34A presents the user with an article screen which displays an article image representing the article as observed from the changed point of view as another point of view. Alternatively, the article screen may be a screen displaying an article image in a two-dimensional coordinate system which represents the article as observed from a predetermined point of view set in advance. The article image presenting part 34A may present the user with an article screen displaying an article image in the two-dimensional coordinate system in place of or in addition to the three-dimensional model 16C.

### [Annotation Data Generation Means]

The annotation data generating part 34B generates annotation data for displaying an annotation screen obtained by writing annotation information on an article screen presented by the article image presenting part 34A. As an example, the annotation information is information indicating a request by the user related to at least a part of work conditions. In addition, when an article manufacturing service is being selected, the annotation information may indicate a request by the user related to at least a part of manufacturing conditions to be instructed with respect to manufacturing an article. In this case, the annotation data generating part 34B generates the annotation data so as to include point of view information which specifies a point of view from which the article displayed on the article screen is to be observed. Furthermore, in order to display the annotation screen on the supplier terminal 60 or the user terminal 40, the annotation data generating part 34B generates the annotation data so as to include an article image expressing the article as observed from the point of view and annotation information to be presented together with the article image.

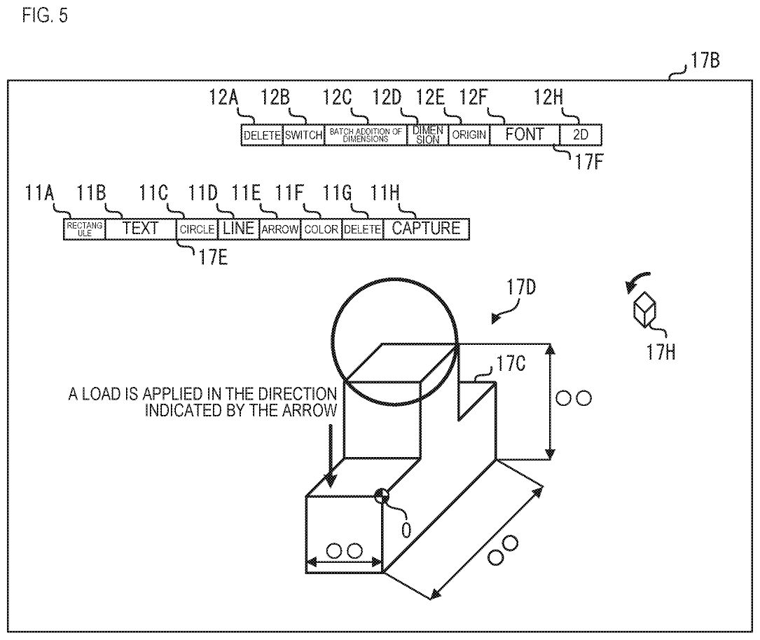

When the user wishes to create an annotation with respect to the supplier, the user designates an image creation icon 16E on the project detail screen. In addition, the annotation data generating part 34B causes the annotation screen shown in FIG. 5 to be displayed. The annotation screen includes an annotation tool 17E as a function provided by the annotation data generating part 34B. As an example, a three-dimensional model 17C is displayed in an image display field 17B of the annotation screen shown in FIG. 5. The user adds annotation information using the annotation tool 17E and an editing tool 17F as functions provided by the annotation data generating part 34B. Specifically, the annotation data generating part 34B causes the annotation tool 17E and the editing tool 17F to be displayed on the annotation screen and the user adds annotation information by designating each of the icons of the tools. Subsequently, the user captures or extracts an image and the annotation data generating part 34B generates annotation data.

Even on the annotation screen, the user can change the point of view from which the three-dimensional model 17C is observed by designating a point of view icon 17H. In addition, the article image presenting part 34A presents the user with the image display field 17B so as to display an article image as viewed from the changed point of view as another point of view. The user can perform editing such as adding, deleting, or changing an element by designating each icon in the annotation tool 17E.

As an example, a rectangular element can be added using a rectangle icon 11A, a text element can be added using a text icon 11B, and a circular or elliptic element can be added using a circle icon 11C. In addition, a linear element can be added using a line icon 11D, an arrow element can be added using an arrow icon 11E, and a color of an added element or an element to be added can be changed using a color icon 11F. Furthermore, an added element can be deleted using a deletion icon 11G, and an annotation image 17D can be captured or extracted using a capture icon 11H. Once editing is completed, the annotation data generating part 34B can title the annotation image 17D including the article image and the annotation information and cause the server memory 22 to store the titled annotation image 17D. Furthermore, the annotation image 17D may be attached to a message created by the communication function provided by the communication part 36A. In this case, when the annotation image 17D is captured or extracted, the annotation data generating part 34B causes the communication part 36A to attach the annotation image 17D to the message.

In addition, the user can perform editing such as adding, deleting, or changing design/manufacturing information and creating a two-dimensional drawing or the like by designating each icon in the annotation tool 17E. As an example, the design/manufacturing information can be deleted using an information deletion icon 12A and switching between displaying and hiding the design/manufacturing information can be performed using a switch icon 12B. In addition, batch addition of dimensions can be performed using a batch addition icon 12C, individual addition of a dimension can be performed using an individual addition icon 12D, and a design origin can be set using a setting icon 12E. Furthermore, a font size can be changed using a change icon 12F and a simplified two-dimensional drawing can be created using a drawing creation icon 12H. The design/manufacturing information is information to be used in design or manufacturing such as dimensions, an origin, or a tolerance.

In the example shown in FIG. 5, the user has added a circular element by designating the circle icon 11C, added an arrow element by designating the arrow icon 11E, and added a text element by designating the text icon 11B. By adding a text element reading “A load is applied in the direction indicated by the arrow” and the arrow element, the user can inform the supplier of a position and a direction where a load is applied. Furthermore, by adding the circular element, the user can inform the supplier of a position of a surface to be processed. Once the editing is completed and the user designates the capture icon 11H, the annotation data generating part 34B generates annotation data so as to include the annotation image 17D including an article image and annotation information made up of the respective added elements and the point of view information specifying a point of view with respect to the article image. In addition, the user can title the annotation data and save the titled annotation data in the server memory 22. Furthermore, the article image presenting part 34A can cause the annotation image 17D to be re-presented in response to an instruction by the user. For example, the article image presenting part 34A causes a thumbnail image of the annotation image 17D to be displayed on the project detail screen. Subsequently, when the user designates the thumbnail image, the article image presenting part 34A causes the annotation image 17D to be re-presented. In addition, the point of view may be made changeable after re-presentation of the annotation image 17D by having the user designate the point of view icon 17H in the image display field 17B. In this case, the article image presenting part 34A re-presents an article image of the article as observed from the different point of view.

Furthermore, the annotation data generating part 34B may generate annotation data so that point of view information specifies a plurality of points of view. For example, the annotation data generating part 34B generates annotation data so as to at least include point of view information which includes one annotation image 17D in a state where the article is observed from one point of view and another annotation image 17D in a state where the article is observed from another point of view and which specifies a plurality of points of view corresponding to the annotation images 17D. In this case, the one annotation image 17D may include annotation information corresponding to the one point of view and the other annotation image 17D may include annotation information corresponding to the other point of view. In addition, the annotation data generating part 34B may generate annotation data so that the one annotation image 17D in a state where the article is observed from the one point of view includes annotation information corresponding to the one point of view and annotation information corresponding to another point of view. Even in this case, the annotation data generating part 34B generates the annotation data so as to include point of view information which specifies a plurality of points of view corresponding to the one annotation image 17D. Accordingly, the supplier can be presented with the annotation image 17D in a state of being observed from each of a plurality of points of view. Furthermore, the user can add annotation information to each of a plurality of article images in a state of being observed from different points of view.

### [Annotation Data Acquisition Means]

The annotation data acquiring part 34C acquires the annotation data generated by the annotation data generating part 34B. As an example, once editing such as adding an element with respect to an article image displayed in association with a desired point of view is completed, the user designates the capture icon 11H in the annotation tool 17E to capture or extract the annotation image 17D. In addition, the article image presenting part 34A saves the annotation image 17D and the annotation data generating part 34B generates annotation data including the annotation image 17D, annotation information, and point of view information. Furthermore, the annotation data generating part 34B causes the server memory 22 to store the generated annotation data. In addition, the annotation data acquiring part 34C acquires the generated annotation data.

Alternatively, an annotation program other than the assistance program PG may cause a user terminal control part 45 or the server control part 23 to function as the article image presenting part 34A or the annotation data generating part 34B. Furthermore, the article image presenting part 34A or the annotation data generating part 34B may be provided in an external server other than the transaction assistance server 20. In this case, the annotation data acquiring part 34C acquires the annotation data generated by the annotation data generating part 34B from the external server.

### [Determination of Provision Requirement]

To describe a determination of a provision requirement, the provision requirement for the supplier to provide an article-related service can be determined based on request information acquired by the request acquiring part 34. For example, when input of request information by the user is completed, the server control part 23 notifies the supplier terminal 60 of the supplier associated with the project via a service card of an estimation request which is an example of a determination request for determining the provision requirement. The supplier terminal 60 can be notified of the determination request by a message created by the communication function provided by the communication part 36A or other means of communication such as e-mail. The supplier refers to the request information, creates estimation contents, and performs an operation to provide the user with an estimation reply. In addition, the server control part 23 notifies the user terminal 40 of the estimation reply. The user downloads from the transaction assistance server 20, for example a written estimate and product specifications as a reply with respect to the estimation reply and confirms them on the user terminal 40. Subsequently, once the user confirms the estimation contents included in the written estimate and performs a determination operation such as determination of a requirement or placement of an order, the server control part 23 saves the product specifications which are an example of determination information indicating the determined provision requirement in the server memory 22.

Furthermore, the supplier can confirm a notification of an estimation request by logging into the transaction assistance system 100 via the supplier terminal 60. As an example, a case list screen is displayed when the supplier logs into the transaction assistance system 100. The server control part 23 notifies the supplier by displaying, on the case list screen, a project for which an estimation request has been made. In addition, the supplier confirms the notification of the determination request by checking the project displayed on the case list screen.

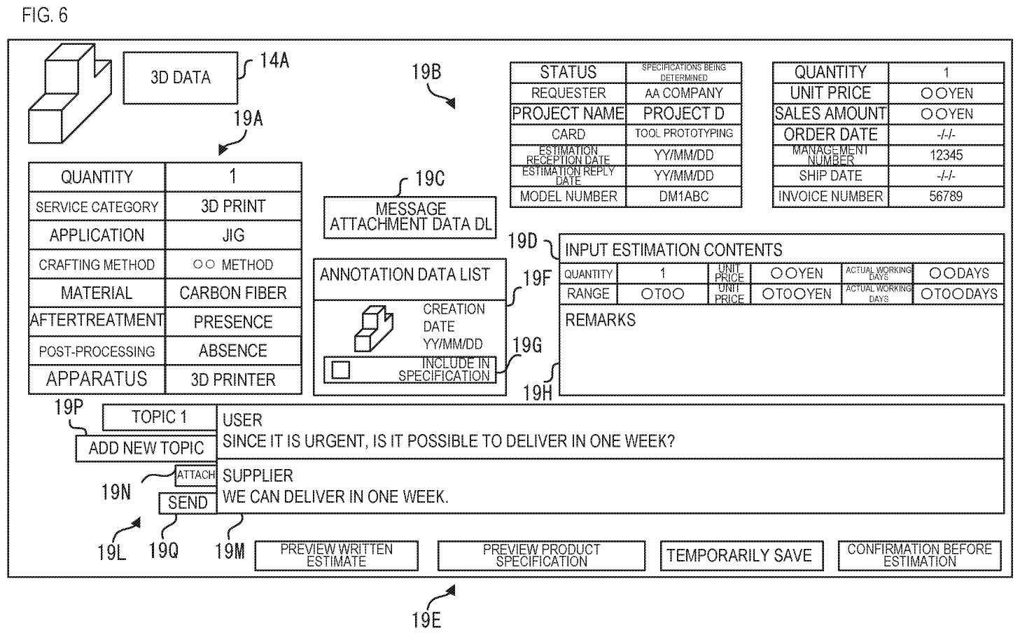

Furthermore, the supplier can create a reply with respect to an estimation request as a determination request by designating a reply icon which is displayed on the case list screen. As an example, the supplier can create a reply on a case detail screen shown in FIG. 6. When the supplier designates the reply icon, the server control part 23 causes the case detail screen to be displayed and causes a request information field 19A to be displayed on the case detail screen. In addition, the server control part 23 presents the supplier with request information acquired by the request acquiring part 34 by causing the request information to be displayed in the request information field 19A. The user has selected or input request information with respect to an information item required by the supplier to determine the provision requirement. Therefore, the supplier can guide the user to select or input information which the supplier needs. Accordingly, the supplier can reduce the possibility of an occurrence of a situation where the supplier makes an inquiry to the user.

In addition, a project content field 19B which indicates contents of a project is displayed at upper right in FIG. 6. The supplier can recognize a status of the project or the like by confirming the project content field 19B. Furthermore, an attached data download icon 19C for downloading data attached to a message including attached data such as an annotation image attached by the communication part 36A is displayed in a center portion in FIG. 6. The supplier can download the attached data from the transaction assistance server 20 to the supplier terminal 60 by designating the attached data download icon 19C.

Furthermore, an input field 19D to be used by the supplier to input estimation contents is displayed below the project content field 19B in FIG. 6. The server control part 23 causes items, for which estimation contents are to be input by the supplier, to be displayed in the input field 19D. In the example shown in FIG. 6, the supplier inputs a unit price of an article, actual working days as a period of time necessary for provision, and necessary remarks as the estimation contents. A quantity is input when a unit price in accordance with the quantity is available. For example, the supplier inputs the quantity when unit prices differ between one to five units and five or more units. In the example shown in FIG. 6, the unit price and the actual working days are only input with respect to a quantity of one. However, the input field 19D may be configured such that a unit price and actual working days are to be input for each of a plurality of quantity conditions or ranges. In addition, the supplier can input a character string indicating a reply, a question, a proposal, or the like with respect to the user in a remarks field 19H.

In the input field 19D, the supplier can input a quantity, a unit price, actual working days, and the like in a mode of designating a range. For example, with respect to actual wording days, a scheduled period until the article can be provided may vary. In such a case, the supplier can input a range such as five to six days. Accordingly, even when input contents vary, an estimation can be input without having to inform the user that the input contents vary.

In addition, an icon field 19E is displayed in a lower part in FIG. 6. By designating each icon, for example, the supplier can display a preview of a written estimate in the display part of the supplier terminal 60. Furthermore, due to the designation of an icon by the supplier, a preview of product specifications can be displayed, input estimation contents can be temporarily saved, and estimation contents can be displayed for confirmation. Once the estimation contents are displayed and final confirmation is completed, the supplier performs an estimation reply operation with respect to the user on a screen (not illustrated) on which the estimation contents are displayed. In addition, the server control part 23 saves the written estimate as the estimation contents and product specifications indicating the provision requirement in the server memory 22 and notifies the user terminal 40 of the estimation reply.

Furthermore, the server control part 23 saves determination information indicating the determined provision requirement in a predetermined server memory 22 so that the user and the supplier can confirm the determination information. For example, in order to reply to the estimation reply, the user downloads the written estimate and the product specifications from the transaction assistance server 20 to the user terminal 40 and confirms the written estimate and the product specifications. Furthermore, after confirming the written estimate and the product specifications, the user performs a determination operation as an instruction of requirement determination. In accordance with the determination operation, the server control part 23 saves the product specifications as determination information indicating the determined provision requirement in the server memory 22 so that the user and the supplier can confirm the product specifications. In addition, the server control part 23 saves the written estimate in the server memory 22 so that the user and the supplier can confirm the written estimate together with the product specifications.

As a result of the confirmation, as request information, the user may upload a revised written estimate or revised product specifications or attach the revised written estimate or the revised product specifications to a message. The revised written estimate or the revised product specifications is acquired by the request acquiring part 34 and presented to the supplier by the server control part 23 in a similar manner to other request information. On the supplier terminal 60, the supplier downloads the revised written estimate or the revised product specifications from the transaction assistance server 20 and confirms the revised written estimate or the revised product specifications. Furthermore, after confirming the revised written estimate or the revised product specifications, the supplier performs a determination operation as an instruction of requirement determination. In accordance with the determination operation, the server control part 23 saves the product specifications as determination information indicating the determined provision requirement in the server memory 22 so that the user and the supplier can confirm the product specifications. In addition, the server control part 23 saves the written estimate in the server memory 22 so that the user and the supplier can confirm the written estimate together with the product specifications.

### [Annotation Presentation Means]

The annotation image presenting part 36B presents, from a point of view corresponding to point of view information included in annotation data generated based on an instruction by one of the user and the supplier, the other of the user and the supplier with an annotation screen based on acquired annotation data. The annotation data includes point of view information which specifies a point of view in a three-dimensional data coordinate system. Therefore, when the supplier views the annotation image 17D, the annotation image presenting part 36B can display the annotation image 17D from the same point of view as the user's point of view. In this case, since annotation information is displayed together with an article image, the supplier can view the annotation information and the article image from a same point of view as at the time of addition of the annotation information by the user. In other words, the article image and the annotation information are displayed on the supplier terminal 60 in a same observation direction as the annotation image 17D displayed on the user terminal 40. Accordingly, an annotation image obtained by the user by adding annotation information to an article image can be presented to the supplier using annotation data. Therefore, the user and the supplier can share correct information regarding the article through simple communication. An example of the annotation image presenting part 36B presenting the user with an annotation screen will be described later.

Next, a flow of displaying an annotation screen will be described with reference to FIG. 6. In FIG. 6, an annotation data field 19F is displayed below the attached data download icon 19C. The supplier designates a thumbnail image indicating the annotation image 17D displayed in the annotation data field 19F. In addition, the annotation image presenting part 36B presents the annotation image 17D to the supplier by causing the annotation screen displaying the annotation image 17D to be displayed in the display part of the supplier terminal 60. In this case, the annotation image 17D presented by the annotation image presenting part 36B is displayed in a state after being edited by the user on the annotation screen shown in FIG. 5 and being stored in the server memory 22 by the annotation data generating part 34B.

In other words, the annotation image presenting part 36B causes an annotation screen such as that shown in FIG. 5 to be displayed in the display part of the supplier terminal 60. At this point, the annotation image presenting part 36B causes the annotation image 17D similar to that shown in FIG. 5 to be displayed on the annotation screen using point of view information in the annotation data. Specifically, the annotation image presenting part 36B presents the supplier with the annotation image 17D from a point of view corresponding to the point of view information included in the annotation data stored in the server memory 22. For example, the annotation image presenting part 36B refers to the point of view information in the annotation data and presents the annotation image 17D so as to include an article image as viewed from a point of view which is specified by the point of view information using three-dimensional model data acquired by the request acquiring part 34. The annotation image 17D includes annotation information added by the user by editing such as an added element and an added text. Therefore, the annotation image presenting part 36B displays the information at the same time as the article image. In addition, when causing an annotation screen to be displayed, the annotation image presenting part 36B causes an article image of the article as observed from a point of view specified by the point of view information in the annotation data to be automatically displayed. Alternatively, the annotation image presenting part 36B may display the article image of the article as observed from the point of view in accordance with a designation of the point of view icon 17H displayed on the annotation screen, a designation of the annotation information displayed on the annotation screen, or the like. In this case, the annotation image presenting part 36B may change the point of view from a point of view corresponding to the article image displayed when displaying the annotation screen to a point of view specified by the point of view information in the annotation data.

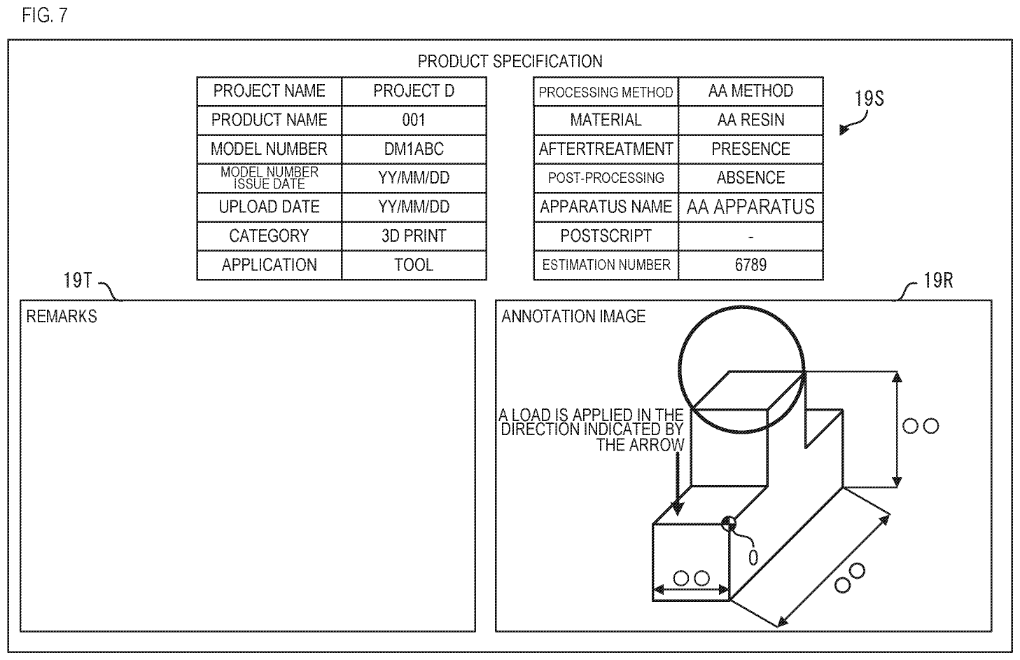

In addition, the annotation data field 19F includes an addition icon 19G for adding the annotation image 17D to the product specifications. When the supplier designates the addition icon 19G, the server control part 23 adds the annotation image 17D to the product specifications. As an example, the server control part 23 saves the product specifications in the server memory 22 so that the annotation image 17D is included in an annotation image field 19R in a lower part of the product specifications such as those shown in FIG. 7. Accordingly, the annotation image 17D stored in the server memory 22 is attached to the product specifications. At this point, when there are a plurality of annotation images 17D, the supplier may select the annotation image 17D to be attached to the product specifications. The product specifications refer to data indicating work conditions and may also be called article specifications, specifications, manufacturing specifications, processing specifications, or the like. In the example shown in FIG. 7, the product specifications include a project content field 19S which shows a provision requirement and project contents and a remarks field 19T. The remarks field 19T shows contents of the remark input by the supplier to the input field 19D of the case detail screen (FIG. 6). In addition, the server control part 23 may automatically create the product specifications so as to include information such as a provision requirement confirmed or corrected by the supplier. Alternatively, the supplier may create the product specifications.

Furthermore, the annotation image presenting part 36B may be capable of changing a presentation mode of the annotation image 17D so that an article is displayed from a point of view which differs from the point of view information included in the annotation data based on an instruction by the supplier. For example, the supplier can change the point of view from which the three-dimensional model 17C is observed by designating the point of view icon 17H on the annotation screen displayed on the supplier terminal 60. In addition, the annotation image presenting part 36B presents the user with the image display field 17B as an article screen which displays an article image as viewed from a point of view after the change or, in other words, from another point of view which differs from the point of view specified by the point of view information in the annotation data. At this point, a presentation mode of the annotation information added by the user by editing may be changed. Specifically, the annotation image presenting part 36B may change a position or a posture of an element or may hide the element.

For example, when a portion indicated by an arrow element is changed to an unobservable point of view by the supplier, the annotation image presenting part 36B may hide the arrow element or change the position or the posture of the element. In this case, the annotation data generating part 34B may generate new annotation data and save the new annotation data in the server memory 22 or may overwrite and save the annotation data. The annotation image presenting part 36B presents the supplier with the annotation image 17D from a point of view corresponding to the point of view information included in the annotation data. The annotation tool 17E and the editing tool 17F are not displayed on the annotation screen displayed on the supplier terminal 60. Alternatively, the supplier may be able to add annotation information from the supplier terminal 60. In this case, the annotation data generating part 34B causes the annotation tool 17E and the editing tool 17F to be displayed on the annotation screen displayed on the supplier terminal 60 in a similar manner to the annotation screen such as that shown in FIG. 5.

When the point of view information in the annotation data specifies a plurality of points of view, the annotation image presenting part 36B may be capable of changing a presentation mode of the annotation screen so that an article is displayed from a specific point of view which is specified from among the plurality of points of view based on an instruction by the user or the supplier. For example, the annotation image presenting part 36B switchably displays one annotation image 17D in a state where the article is observed from one point of view and another annotation image 17D in a state where the article is observed from another point of view. In this case, the annotation image presenting part 36B may display the article image of the article as observed from a point of view selected from among the plurality of points of view in accordance with a designation of the point of view icon 17H displayed on the annotation screen, a designation of the annotation information displayed on the annotation screen, or the like. At this point, the point of view selected by the annotation image presenting part 36B may be switched in a predetermined order every time the point of view icon 17H is designated. For example, the annotation image presenting part 36B sequentially selects article images starting from an earliest created article image or from a latest created article image and sequentially selects points of view corresponding to the selected article image. Alternatively, the annotation image presenting part 36B selects a point of view corresponding to the annotation information designated by the user. For example, the annotation image presenting part 36B switchably displays annotation information corresponding to the one point of view and annotation information corresponding to the other point of view.

### [Communication Means]

The communication part 36A provides the user and the supplier with a function for communication (also referred to as a communication function in the present specification). In addition, the communication part 36A provides the user and the supplier set in association with a selected service with a communication function for adjusting a determination of a provision requirement. As an example, the communication function is a function for mutually transmitting texts, sound, images, or other data between the user and the supplier.

For example, a user chat icon 16F is displayed in a lower part of the project detail screen shown in FIG. 4. When the user designates the user chat icon 16F, the communication part 36A causes a user chat region 17L for inputting or uploading data to be transmitted from the user to the supplier to be displayed. As an example, the communication part 36A causes the user chat region 17L to be displayed as shown in FIG. 4. In the example shown in FIG. 4, the user chat region 17L includes a user message field 17M, a user chat tool 17N, a user topic tool 17P, and a user transmission icon 17Q. The user can input a message to the user message field 17M and a message input by the supplier is displayed in the user message field 17M. Accordingly, the supplier and the user can communicate with each other.

In addition, using an attachment icon 13A in the user chat tool 17N, the user can select data and attach the data to a message. Furthermore, the user can capture or extract and save an article image using a capture icon 13B and can activate the annotation tool 17E using a tool icon 13C. Furthermore, the user can use the user topic tool 17P to create a new topic. The communication part 36A displays messages between the user and the supplier for each topic. Therefore, the supplier and the user can communicate with each other via messages for each topic. In addition, once the user creates a message, the user designates the user transmission icon 17Q and the communication part 36A transmits the message to the supplier.

In addition, in a case of a screen displayed on the supplier terminal 60, as shown in FIG. 6, the communication part 36A causes a supplier chat region 19L for inputting or uploading data to be transmitted from the supplier to the user to be displayed. In the example shown in FIG. 6, the supplier chat region 19L includes a supplier message field 19M, a supplier chat tool 19N, a supplier topic tool 19P, and a supplier transmission icon 19Q. The supplier can input a message to the supplier message field 19M and a message input by the user is displayed in the supplier message field 19M. Accordingly, the supplier and the user can communicate with each other.

In addition, using the supplier chat tool 19N, the supplier can select data and attach the data to a message. Furthermore, the supplier can use the supplier topic tool 19P to create a new topic. The communication part 36A displays messages between the user and the supplier for each topic. In addition, once the supplier creates a message, the supplier designates the supplier transmission icon 19Q and the communication part 36A transmits the message to the user.

In addition, when the provision requirement includes at least any one of a delivery time and an estimation related to a service as an acceptance condition of the supplier, the communication part 36A provides a communication function so as to give the supplier an opportunity to present the acceptance condition to the user. In the example shown in FIG. 6, a question message input by the user and related to the delivery time and a reply message input by the supplier are displayed in the supplier message field 19M. In this case, “1 week” is the acceptance condition of the supplier and the communication part 36A transmits a message including the acceptance condition to the user. Accordingly, the communication part 36A gives the supplier an opportunity to present the acceptance condition to the user. The delivery time includes the actual wording days described earlier.

In addition, an estimation as the acceptance condition includes a quantity, a unit price, a quality, a total price, or the like and the communication part 36A transmits a message including the estimation to the user. Alternatively, the communication part 36A may transmit data indicating contents of the delivery time or contents of the estimation to the user by attaching the data to a message. The mutual communication of messages by the communication part 36A may be performed directly in real time between the user terminal 40 and the supplier terminal 60 or performed via the transaction assistance server 20. In addition, a communication program other than the assistance program PG may cause the user terminal control part 45 or the server control part 23 to function as the communication part 36A. Furthermore, the communication part 36A may be provided in an external server other than the transaction assistance server 20. In this case, the mutual communication of messages is performed via the external server.

[Management Means]

The managing part 37 generates a project in association with the selection of a service by the service selecting part 33. In addition, the managing part 37 separately manages communication via the communication part 36A per project so that each of the user and the supplier can select a project and engage in communication. As an example, the managing part 37 generates project data 25 (FIG. 2), attaches project identification information to the project data 25, and causes the server memory 22 to store the project data 25. In addition, the managing part 37 includes message data 25E in the project data 25 together with request information 25A, determination information 25B, three-dimensional model data 25C, and annotation data 25D. Furthermore, the managing part 37 may include information indicating contents of the project such as a management number in the project data 25.

When the user or the supplier selects a project and uses the communication function, the communication part 36A uses the project identification information of the selected project to refer to the message data 25E included in the project data 25. Accordingly, the communication part 36A can present the user and the supplier with a message created in the selected project. In addition, when the user or the supplier creates a new message, the managing part 37 includes the new message in the message data 25E and causes the server memory 22 to store the message data 25E. Accordingly, the managing part 37 separately manages communication per project.

[Storage Means]

The server memory 22 saves the determination information 25B which indicates a provision requirement for the supplier to provide an article-related service and which includes annotation information so that the user and the supplier can confirm the determination information 25B. As an example, the determination information 25B is data constituting the product specifications shown in FIG. 7 and the annotation information is included in an annotation image of the product specifications. In addition, as shown in FIG. 2, the server memory 22 stores the assistance program PG, the card data 24, the project data 25, and the requirement data 26. The card data 24 is created by the supplier or the manager of the transaction assistance server 20 and, in the example shown in FIG. 2, includes the content information 24A, the supplier information 24B, and the case example information 24C. In addition, the project data 25 includes the request information 25A, the determination information 25B, the three-dimensional model data 25C, the annotation data 25D, and the message data 25E. The requirement data 26 includes the information item data 26A.

[User Terminal and Supplier Terminal]

The user terminal 40 includes the user terminal control part 45 which controls the user terminal 40 and a user terminal memory 44 which is an example of a user terminal storage part storing a control program (not illustrated). The user terminal control part 45 is configured as a computer combining a processor which executes various calculation processing steps and operation control in accordance with a predetermined program with other peripheral apparatuses. In addition, the user terminal 40 includes a user terminal display 46 which is an example of a display part for displaying a web page generated by the transaction assistance server 20.

Furthermore, the user terminal 40 includes a user terminal communicating part 47 as an example of a communication apparatus which transmits and receives data to and from the transaction assistance server 20. The user terminal 40 may directly transmit and receive data to and from the supplier terminal 60 using the user terminal communicating part 47. In addition, the user terminal 40 includes an input part (not illustrated) which is an example of an input apparatus including a keyboard or various switches for inputting commands and data. Alternatively, a display part such as a touch panel may function as the input part.

The supplier terminal 60 includes a supplier terminal control part 65 which controls the supplier terminal 60 and a supplier terminal memory 64 which is an example of a supplier terminal storage part storing a control program (not illustrated). The supplier terminal control part 65 is configured as a computer combining a processor which executes various calculation processing steps and operation control in accordance with a predetermined program with other peripheral apparatuses. In addition, the supplier terminal 60 includes a supplier terminal display 66 which is an example of a display part for displaying a web page generated by the transaction assistance server 20.

Furthermore, the supplier terminal 60 includes a supplier terminal communicating part 67 as an example of a communication apparatus which transmits and receives data to and from the transaction assistance server 20. The supplier terminal 60 may directly transmit and receive data to and from the user terminal 40 using the supplier terminal communicating part 67. In addition, the supplier terminal 60 includes an input part (not illustrated) which is an example of an input apparatus including a keyboard or various switches for inputting commands and data. Alternatively, a display part such as a touch panel may function as the input part.

The user terminal control part 45 and the supplier terminal control part 65 are similar to the server control part 23 in terms of being configured as a computer including a processor such as a CPU. In addition, the user terminal memory 44 and the supplier terminal memory 64 are similar to the server memory 22 in terms of being configured as a computer-readable non-transitory storage medium including a ROM, an HDD, or the like. As such, detailed descriptions of the user terminal control part 45 and the supplier terminal control part 65, and the user terminal memory 44 and the supplier terminal memory 64, will be omitted.

[Assistance Flow]

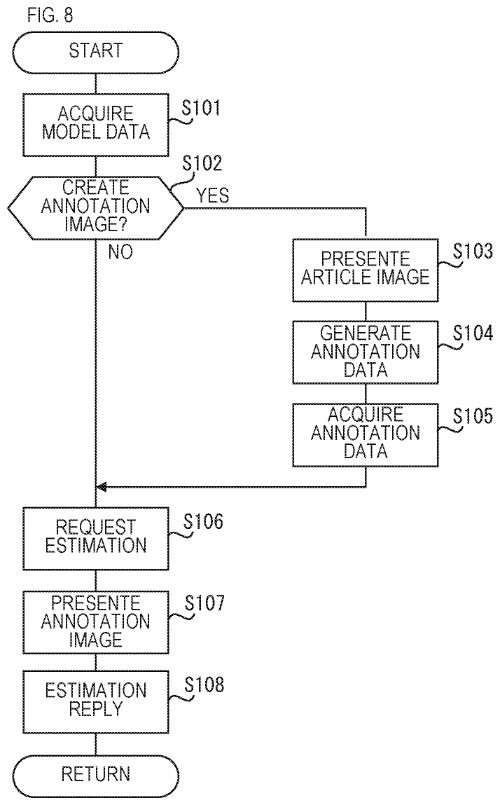

Referring to FIG. 8, an example of an assistance flow by the transaction assistance system 100 will be described. First, the supplier or the manager of the transaction assistance server 20 inputs an article-related service to be included in a service candidate group and service information corresponding to the service to the transaction assistance server 20. In addition, the service setting part 31 sets, in association with the service information, the service card as information which enables the user to comprehend the input service. Accordingly, the service setting part 31 sets, in association with service information of each service, a service candidate group including a plurality of services.

In addition, the supplier or the manager of the transaction assistance server 20 inputs an information item for each set service card. Furthermore, the information item setting part 32 sets the input information item as an item for which the user can input or select request information. Accordingly, the information item setting part 32 sets an information item for each service included in the service candidate group. Next, the service selecting part 33 causes the service candidate group including a plurality of the service cards to be displayed on the service card list screen of a web page accessed by the user. Accordingly, the service selecting part 33 presents the user with each service included in the service candidate group as an option in selecting a service.

The user refers to the service content screen, the supplier screen, or the case example screen which is displayed by performing a search using a keyword or by designating one of the service cards. In addition, the user selects the service card associated with a desired service from among the plurality of service cards being presented. In response to the selection, the service selecting part 33 acquires service specific information (for example, card identification information) for specifying the service selected by the user. Furthermore, the service selecting part 33 selects the service specified by the service specific information from the service candidate group.

Once the selection of a service card is completed, the user determines the service card on the service card list screen. In addition, the managing part 37 generates a project in association with the selection of a service by the service selecting part 33. Accordingly, the selected service is included in a project. In addition, the project list screen including the project generated by the managing part 37 is displayed on the user terminal 40. Furthermore, when the user selects a project on the project list screen, the project detail screen (FIG. 4) is displayed. The user uploads three-dimensional model data on the project list screen and selects or inputs request information with respect to information items displayed on the project detail screen.

The request acquiring part 34 acquires the three-dimensional model data (S101) and, acquires information selected or input by the user. Accordingly, communication between the user and the supplier can be facilitated. When desiring to communicate with the supplier, the user designates the user chat icon 16F on the project detail screen. In addition, the communication part 36A activates the communication function and causes the user chat region 17L to be displayed (FIG. 4). Once the user inputs a message and designates the user transmission icon 17Q, the communication part 36A transmits the message to the supplier.

In addition, when the user desires to create the annotation image 17D (YES in S102), the user designates the image creation icon 16E on the project detail screen. Furthermore, the article image presenting part 34A causes the annotation screen (FIG. 5) to be displayed. The annotation screen includes the annotation tool 17E as a function provided by the annotation data generating part 34B. On the annotation screen, the article image presenting part 34A causes an article image in a state of being observed from a predetermined point of view to be displayed (S103). In addition, when the user changes the point of view from which the three-dimensional model 17C is observed, the article image presenting part 34A causes an article image in a state of being observed from the changed point of view to be displayed.

Furthermore, the user adds necessary elements using the annotation tool 17E. Subsequently, the user operates the annotation tool 17E to capture or extract an image and the annotation data generating part 34B generates annotation data for displaying the annotation image 17D on the supplier terminal 60 (S104). In addition, the annotation data acquiring part 34C acquires the generated annotation data (S105). The communication with the supplier and the creation of the annotation image 17D can be performed at any time by the user. In addition, communication by the communication function and the creation of annotation data may be performed in any order.

Subsequently, once the input of request information is completed, the server control part 23 notifies the supplier terminal 60 of a request for estimation as a determination request (S106). The supplier comprehends the project in which a request for estimation has been made on the case list screen. In addition, the supplier designates the reply icon on the case list screen and the server control part 23 causes the case detail screen (FIG. 6) to be displayed. The request information field 19A is displayed on the case detail screen and a situation where the supplier asks the user for further information is avoided. Accordingly, an accurate request by the user can be presented to the supplier with minimal processing. When the supplier designates a thumbnail image indicating the annotation image 17D displayed in the annotation data field 19F on the case detail screen, the annotation image presenting part 36B displays the annotation image 17D. In addition, the supplier can also communicate with the user using the supplier chat region 19L.

The supplier inputs estimation contents via the input field 19D. In addition, the supplier may designate the addition icon 19G to add the annotation image 17D to product specifications. Once the estimation is completed, the supplier performs an operation of an estimation reply with respect to the user. In addition, the server control part 23 saves the written estimate as the estimation contents and product specifications indicating the provision requirement in the server memory 22 and notifies the user terminal 40 of the estimation reply (S108). The user downloads the written estimate and the product specifications from the transaction assistance server 20 to the user terminal 40 and confirms the written estimate and the product specifications. If all is satisfactory, the user performs a determination operation as an instruction of requirement determination. In addition, the server control part 23 saves the product specifications as determination information indicating the determined provision requirement in the server memory 22 so that the user and the supplier can confirm the product specifications. Accordingly, the processing ends. Furthermore, the determination operation by the user may be an operation for ordering the provision of a service. The operation can be performed on an order screen (not illustrated) displayed by the server control part 23.

[Modifications]

As a modification, an example of the article image presenting part 34A presenting the supplier with an article screen and an example of the annotation image presenting part 36B presenting the user with an annotation screen will be described. In the modification, the annotation image 17D is created on the supplier terminal 60. However, the annotation image 17D may also be created on the supplier terminal 60 in the embodiment described earlier.

The case detail screen shown in FIG. 6 is displayed on the supplier terminal 60. For example, when the supplier designates a display icon 14A on the case detail screen, the article image presenting part 34A causes an article screen to be displayed on the supplier terminal 60 based on the three-dimensional model data acquired by the request acquiring part 34. At this point, the article image presenting part 34A causes an article screen expressing the article as observed from a predetermined point of view to be displayed. The article observed from another point of view which differs from an initial point of view may be displayed. As an example, when the point of view of observation in the article image already being displayed is changed, the article image presenting part 34A presents the user with an article screen which displays an article image representing the article as observed from the changed point of view as another point of view.

In addition, in the modification, the annotation data generating part 34B generates annotation data for displaying an annotation screen obtained by writing annotation information on an article screen presented by the article image presenting part 34A. As an example, the annotation information is information related to at least a part of work conditions and indicates a proposal of work conditions which can be provided by the supplier, a question with respect to use conditions which have become additionally necessary, or the like. For example, when the annotation information indicates a question, contents of the question relate to at least a part of the work conditions in terms of indicating work conditions required by the supplier. In this case, the annotation data generating part 34B generates the annotation data so as to include point of view information which specifies a point of view from which the article displayed on the article screen is to be observed. In addition, in order to cause the annotation screen to be displayed on the user terminal 40, the annotation data generating part 34B generates the annotation data so as to include an article image expressing an article as observed from the point of view and annotation information to be presented together with the article image. Furthermore, the annotation data acquiring part 34C acquires the annotation data generated by the annotation data generating part 34B.

As an example, when the supplier desires to create an annotation with respect to the user, the supplier designates the image creation icon 16E such as that shown in FIG. 4 on a screen which is displayed by designating the display icon 14A. In the modification, the image creation icon 16E is displayed together with the model display field 16B. Accordingly, the annotation data generating part 34B causes the annotation screen shown in FIG. 5 to be displayed. The annotation screen includes the annotation tool 17E as a function provided by the annotation data generating part 34B. In addition, the three-dimensional model 17C is displayed in the image display field 17B of the annotation screen. Furthermore, the supplier adds annotation information using the annotation tool 17E and the editing tool 17F as functions provided by the annotation data generating part 34B. Subsequently, the supplier captures or extracts an image and the annotation data generating part 34B generates annotation data. Even on the annotation screen, the supplier can change the point of view from which the three-dimensional model 17C is observed by designating the point of view icon 17H. In addition, the article image presenting part 34A presents the supplier with the image display field 17B as an article screen for displaying an article image as viewed from the changed point of view as another point of view.

The annotation image presenting part 36B presents, from a point of view corresponding to point of view information included in annotation data generated based on an instruction by the supplier, the user with an annotation screen based on acquired annotation data. For example, in the modification, the project detail screen displayed on the user terminal 40 includes the annotation data field 19F such as that shown in FIG. 6. In addition, the user designates a thumbnail image indicating the annotation image 17D displayed in the annotation data field 19F. The annotation image presenting part 36B presents the annotation image 17D to the user by causing the annotation screen displaying the annotation image 17D to be displayed in the display part of the user terminal 40. In this case, the annotation image 17D presented by the annotation image presenting part 36B is displayed in a state after being edited by the supplier and being stored in the server memory 22 by the annotation data generating part 34B. Therefore, when the user views the annotation image 17D, the annotation image presenting part 36B can display the annotation image 17D from the same point of view as the supplier's point of view.

Furthermore, in the modification, when the point of view information in the annotation data specifies a plurality of points of view, the annotation image presenting part 36B may be capable of changing a presentation mode of the annotation screen so that the article is displayed from a specific point of view which is specified from among the plurality of points of view based on an instruction by the user.

According to the transaction assistance system 100 related to the embodiment described above, an annotation image obtained by one of the user and the supplier by adding annotation information to an article image can be presented to the other of the user and the supplier using annotation data. Therefore, the user and the supplier can share correct information regarding the article through simple communication.

While the present invention has been described above with reference to each embodiment, the present invention is not limited to the above embodiments. Rather, it is to be understood that the present invention also includes inventions modified without departing from the scope of the present invention and inventions equivalent to the present invention. In addition, each embodiment and each modification can be appropriately combined without departing from the scope of the present invention.

For example, the assistance system need only be a system in which communication is performed and is not limited to the transaction assistance system 100 for assisting with the closing of a transaction. As an example, the assistance system may be a data sharing system used by the user to transmit three-dimensional model data and annotation data to the supplier in order to share the three-dimensional model data. In this case, the three-dimensional model data and the annotation data may be temporarily saved in the data sharing system. Alternatively, the assistance system may be a data saving system used by the user to save uploaded three-dimensional model data and annotation data in order to enable the supplier to view the three-dimensional model data and the annotation data.

In addition, a part of each functional part included in the transaction assistance server 20 may be provided in at least one of the user terminal 40 and the supplier terminal 60. As an example, the request acquiring part 34 may be provided in the user terminal 40 and the user terminal 40 may transmit acquired request information to the transaction assistance server 20 or the supplier terminal 60. In addition, when a part of each functional part included in the transaction assistance server 20 is provided in at least one of the user terminal 40 and the supplier terminal 60, the assistance program PG and the control program of at least one of the user terminal 40 and the supplier terminal 60 cooperate with each other to function as a computer program of the transaction assistance system 100. Furthermore, the transaction assistance system 100 is constituted of the transaction assistance server 20 and at least one of the user terminal 40 and the supplier terminal 60.

In addition, the transaction assistance server 20 may further include a function of automatically creating estimation contents. The supplier can confirm the estimation created by the function and perform an estimation reply after making necessary modifications.

In the present specification, an article may be an object constructed by combining a plurality of parts or a single whole object. Alternatively, an article may be an assembly of modules, units, or the like which exhibit functions by being incorporated into a finished product.

A part of or all of the embodiments described above may be described as, but not limited to, the following supplementary notes.

[Supplementary Note 1]

A server apparatus assisting with communication between a supplier providing an article-related service which requires work related to an article and a user demanding provision of the article-related service, the server apparatus comprising:
an acquisition unit configured to acquire three-dimensional model data of the article based on an instruction by the user;
an article presentation unit configured to present one of the user and the supplier with an article screen, which expresses the article as observed from a predetermined point of view, based on the three-dimensional model data;
an annotation data generation unit configured to generate annotation data for displaying an annotation screen obtained by writing annotation information on the presented article screen so that the annotation data includes point of view information which specifies the point of view;
an annotation data acquisition unit configured to acquire the generated annotation data; and
an annotation presentation unit configured to present another of the user and the supplier with the annotation screen based on the acquired annotation data from a point of view corresponding to the point of view information included in the annotation data.

### REFERENCE SIGNS LIST

22: server memory (storage unit)
23: server control part (computer)
34: request acquiring part (acquisition unit)
34A: article image presenting par (article presentation unit)
34B: annotation data generating part (annotation data generation unit)
34C: annotation data acquiring part (annotation data acquisition unit)
36A: communication part (communication unit)
36B: annotation image presenting part (annotation presentation unit)
100: transaction assistance system (assistance system)
PG: assistance program (computer program)

1. An assistance system assisting with communication between a supplier providing an article-related service which requires work related to an article and a user demanding provision of the article-related service, the assistance system comprising:
a processor, wherein
the processor is configured to acquire three-dimensional model data of the article based on an instruction by the user;
the processor is configured to present one of the user and the supplier with an article screen, which expresses the article as observed from a predetermined point of view, based on the three-dimensional model data;
the processor is configured to generate annotation data for displaying an annotation screen obtained by writing annotation information on the presented article screen so that the annotation data includes point of view information which specifies the point of view from which the article displayed on the article screen has been observed;
the processor is configured to acquire the generated annotation data; and
the processor is configured to present another of the user and the supplier with the annotation screen based on the acquired annotation data from a point of view corresponding to the point of view information included in the annotation data.

2. The assistance system according to claim 1, wherein the processor is causes the article to be displayed as observed from another point of view which differs from the point of view based on an instruction by the user or the supplier.

3. The assistance system according to claim 1, wherein the processor is generates the annotation data so as to include an article image expressing the article as observed from the point of view and the annotation information to be presented together with the article image.

4. The assistance system according to claim 1, wherein the processor generates the annotation data so that the point of view information specifies a plurality of points of view; and
the processor is is capable of changing a presentation mode of the annotation screen so that the article is displayed from a specific point of view which is specified from among the plurality of points of view based on an instruction by the user or the supplier.

5. The assistance system according to claim 1, wherein the article-related service includes an article manufacturing service which requires manufacturing of the article by the supplier as the work, and
the annotation information indicates a request by the user related to at least a part of a manufacturing condition to be instructed with respect to the manufacturing of the article.

6. The assistance system according to claim 1, wherein
the processor is configured to provide a function of the communication to the user and the supplier.

7. The assistance system according to claim 1, wherein the processor further acquires a work condition, which designates a condition of work to be performed by the supplier with respect to the article, based on an instruction by the user, and
the assistance system further has a memory configured to store determination information, which indicates a provision requirement for providing the article-related service by the supplier and includes the annotation information, so that the user and the supplier enables to confirm the determination information.

8. A computer-readable non-transitory storage medium storing a computer program for an assistance system which includes a computer and which is configured to assist with communication between a supplier providing an article-related service which requires work related to an article and a user demanding provision of the article-related service, the computer program causing the computer to:
acquire three-dimensional model data of the article based on an instruction by the user;
configured to present one of the user and the supplier with an article screen, which expresses the article as observed from a predetermined point of view, based on the three-dimensional model data;
configured to generate annotation data for displaying an annotation screen obtained by writing annotation information on the presented article screen so that the annotation data includes point of view information which specifies the point of view from which the article displayed on the article screen has been observed;
acquire the generated annotation data; and
present another of the user and the supplier with the annotation screen based on the acquired annotation data from a point of view corresponding to the point of view information included in the annotation data.

9. A method of control for an assistance system which includes a computer and which is configured to assist with communication between a supplier providing an article-related service which requires work related to an article and a user demanding provision of the article-related service, the method of control causing the computer to:
acquire three-dimensional model data of the article based on an instruction by the user;
present one of the user and the supplier with an article screen, which expresses the article as observed from a predetermined point of view, based on the three-dimensional model data;
generate annotation data for displaying an annotation screen obtained by writing annotation information on the presented article screen so that the annotation data includes point of view information which specifies the point of view from which the article displayed on the article screen has been observed;
acquire the generated annotation data; and
present another of the user and the supplier with the annotation screen based on the acquired annotation data from a point of view corresponding to the point of view information included in the annotation data.
